(19) United States
(12) Patent Application Publication
(10) Pub. No.: US 2020/0369343 A1
(43) Pub. Date: Nov. 26, 2020

(54) BICYCLE REAR DERAILLEUR

(71) Applicant: TEKTRO TECHNOLOGY CORPORATION, Changhua County (TW)

(72) Inventor: Yen Hui CHIANG, Changhua County (TW)

(21) Appl. No.: 16/695,954

(22) Filed: Nov. 26, 2019

(30) Foreign Application Priority Data
May 24, 2019 (TW) 108118070

(51) Int. Cl. B62M 9/126; B62M 9/1248

(52) U.S. Cl. CPC B62M 9/126; B62M 9/1248

(57) ABSTRACT

The disclosure provides a bicycle rear derailleur. The bicycle rear derailleur is configured to be mounted on a bicycle frame. The bicycle rear derailleur includes a linkage assembly, a chain guide, a pivot, a one-way bearing, a connecting component and at least one resistance applying component. An end of the pivot is fixed on the chain guide. The one-way bearing is sleeved on the pivot. The connecting component is disposed on the linkage assembly and connected to the one-way bearing. The one-way bearing allows the pivot to rotate with respect to the connecting component only in a rotation direction. The resistance applying component is radially movable. The resistance applying component is configured to radially press against the connecting component to provide resistance to rotational movements of the pivot, the one-way bearing, and the connecting component in a direction opposite to the rotation direction.

### CROSS-REFERENCE TO RELATED APPLICATIONS

This non-provisional application claims priority under 35 U.S.C. § 119(a) on Patent Application No(s). 108118070 filed in Taiwan, R.O.C. on May 24, 2019, the entire contents of which are hereby incorporated by reference.

### TECHNICAL FIELD

This disclosure relates to a bicycle rear derailleur, more particularly to a bicycle rear derailleur having a resistance applying component.

### BACKGROUND

In recent years, road bikes, mountain bikes and other types of bicycles are all popular in the market, and it motivates bicycle manufacturers to pay more attention on improving their products.

To a bicycle rear derailleur, a chain guide is pivotably disposed on a four-link mechanism via a pivot, and there is torsion spring connected between the chain guide and the four-link mechanism. The torsion spring provides a torque to the chain guide to tension a bicycle chain.

### SUMMARY OF THE INVENTION

One embodiment of the disclosure provides a bicycle rear derailleur. The bicycle rear derailleur is configured to be mounted on a bicycle frame. The bicycle rear derailleur includes a linkage assembly, a chain guide, a pivot, a one-way bearing, a connecting component and at least one resistance applying component. An end of the pivot is fixed on the chain guide. The one-way bearing is sleeved on the pivot. The connecting component is disposed on the linkage assembly and connected to the one-way bearing. The one-way bearing allows the pivot to rotate with respect to the connecting component only in a rotation direction. The resistance applying component is radially movable. The resistance applying component is configured to radially press against the connecting component to provide resistance to rotational movements of the pivot, the one-way bearing, and the connecting component in a direction opposite to the rotation direction.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a bicycle rear derailleur according to a first embodiment of the disclosure;

FIG. 2 is an exploded view of the bicycle rear derailleur in FIG. 1;

FIG. 3 is a cross-sectional view of the bicycle rear derailleur in FIG. 1;

FIG. 4 is another cross-sectional view of the bicycle rear derailleur in FIG. 1;

FIG. 5 is a cross-sectional view of the bicycle rear derailleur in FIG. 1 when resistance applying components press against an annular surface of the connecting component;

FIG. 6 is a cross-sectional view of a bicycle rear derailleur according to a second embodiment of the disclosure;

FIG. 7 is a partial cross-sectional view of a bicycle rear derailleur according to third second embodiment of the disclosure; and

FIG. 8 is a perspective view of a bicycle rear derailleur according to a fourth embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

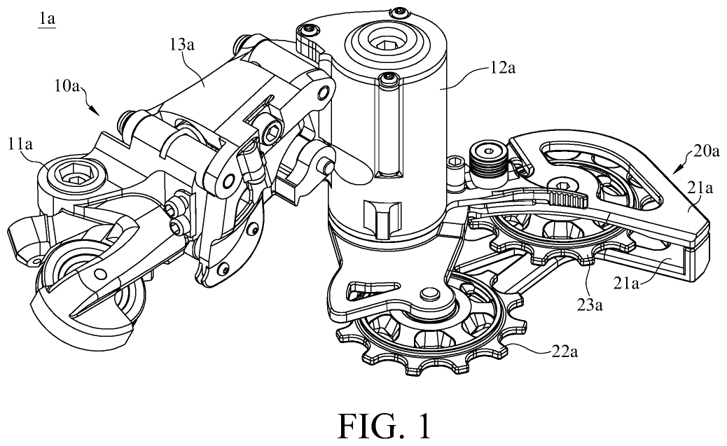

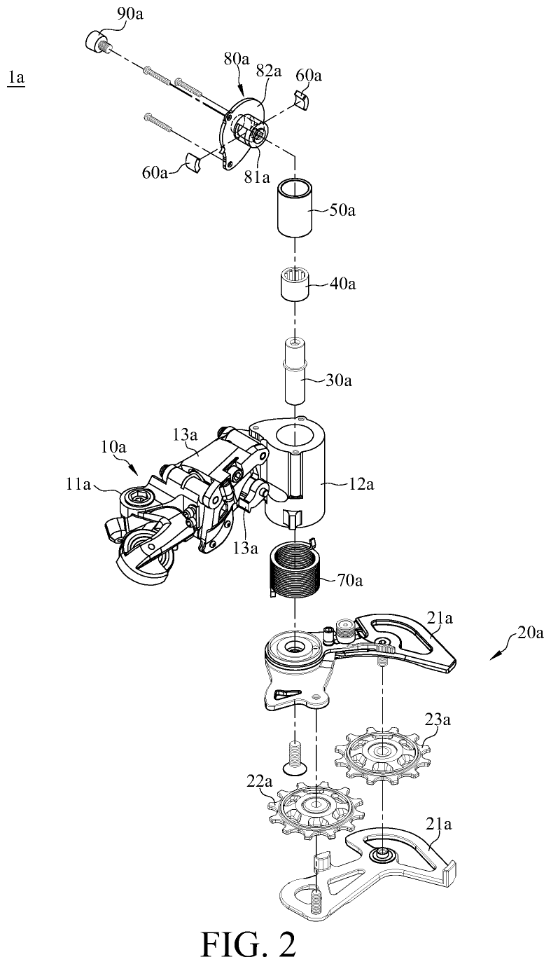

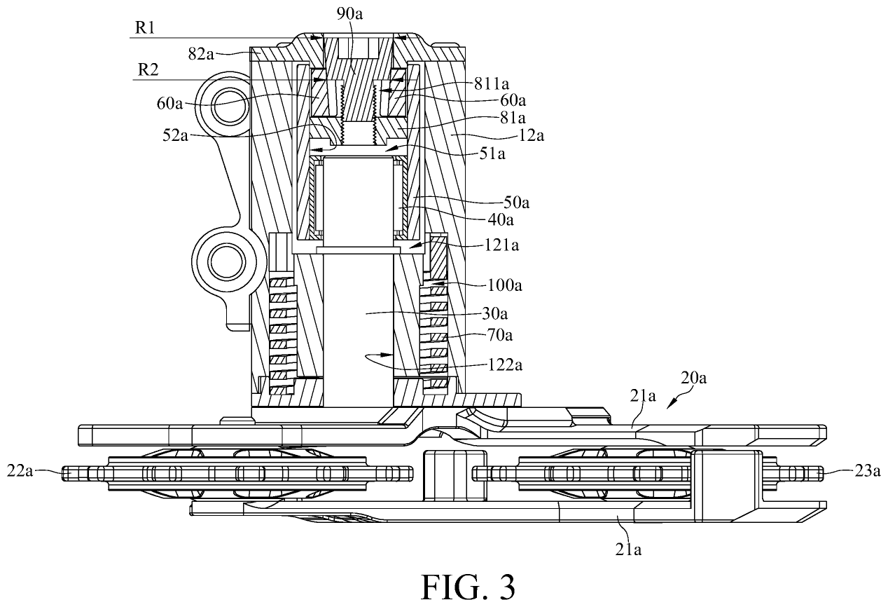

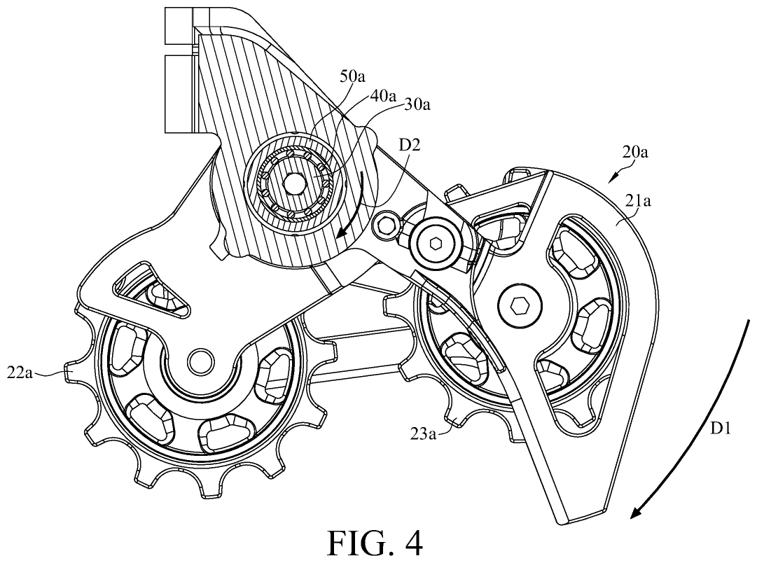

Referring to FIGS. 1 to 4, FIG. 1 is a perspective view of a bicycle rear derailleur 1a according to a first embodiment of the disclosure, FIG. 2 is an exploded view of the bicycle rear derailleur 1a in FIG. 1, FIG. 3 is a cross-sectional view of the bicycle rear derailleur 1a in FIG. 1, and FIG. 4 is another cross-sectional view of the bicycle rear derailleur 1a in FIG. 1.

In this embodiment, the bicycle rear derailleur 1a includes a linkage assembly 10a, a chain guide 20a, a pivot 30a, a one-way bearing 40a, a connecting component 50a, and two resistance applying components 60a. In addition, the bicycle rear derailleur 1a may further include an elastic component 70a, a mount component 80a and a resistance controlling component 90a.

The linkage assembly 10a includes a fixed component 11a, a movable component 12a, and two links 13a. The fixed component 11a is configured to be mounted on a bicycle frame (not shown). Two opposite ends of each link 13a are respectively and pivotably disposed on the fixed component 11a and the movable component 12a. The chain guide 20a includes two frame bodies 21a, a guide pulley 22a, and a tension pulley 23a. The guide pulley 22a and the tension pulley 23a are rotatably located between the frame bodies 21a. One end of the pivot 30a is fixed to one of the frame bodies 21a. In this embodiment, the frame bodies 21a are separate pieces, and the frame bodies 21a may be made of metal or non-metal material. In one embodiment, the frame bodies 21a may be respectively a metal piece and a non-metal piece. The non-metal material may be carbon fiber compound or glass fiber compound.

In this embodiment, the movable component 12a has a first accommodation space 121a and a second accommodation space 122a connected to each other. The pivot 30a is disposed through the second accommodation space 122a. The pivot 30a is partially located in second accommodation space 122a and partially located in the first accommodation space 121a. The movable component 12a and the frame body 21a of the chain guide 20a together form an annular space 100a therebetween, and the annular space 100a surrounds the second accommodation space 122a. The elastic component 70a is, for example, a torsion spring. The elastic component 70a is located in the annular space 100a, and two opposite ends of the elastic component 70a are respectively fixed to the movable component 12a and the frame body 21a of the chain guide 20a. The elastic component 70a is configured to force the chain guide 20a to pivot in a pivot direction D1 so as to cause the tension pulley 23a to increase the tension of a chain thereon. During the movement of the chain guide 20a in the pivot direction D1, the chain guide 20a forces the pivot 30a to rotate in a rotation direction D2.

The one-way bearing 40a is located in the first accommodation space 121a and sleeved on the pivot 30a. In this embodiment, the elastic component 70a and the one-way bearing 40a are arranged along an axial direction of the pivot 30a. The connecting component 50a is, for example, a sleeve. The connecting component 50a has an insertion hole 51a and an annular inner surface 52a forming the insertion hole 51a. The connecting component 50a is located in the first accommodation space 121a. The one-way bearing 40a is located in the insertion hole 51a of the connecting component 50a and in tight contact with the annular inner surface 52a of the connecting component 50a. In this embodiment, the one-way bearing 40a allows the pivot 30a to rotate with respect to the connecting component 50a only along the rotation direction D2.

The mount component 80a includes a pillar portion 81a and a flange portion 82a. The flange portion 82a radially protrudes from the pillar portion 81a. The flange portion 82a is fixed on the movable component 12a. The pillar portion 81a is partially located in the insertion hole 51a of the connecting component 50a. The pillar portion 81a is located at a side of the one-way bearing 40a away from the chain guide 20a. The pillar portion 81a of the mount component 80a has a mount hole 811a. The resistance applying components 60a are movably disposed on the portion of the pillar portion 81a located in the insertion hole 51a, and the resistance applying components 60a are located between the mount hole 811a and the annular inner surface 52a of the connecting component 50a. In this embodiment, the resistance applying components 60a and the pillar portion 81a of the mount component 80a are separate pieces.

The resistance controlling component 90a is, for example, a hex socket cap screw. There are, for example, inner threads in the mount hole 811a of pillar portion 81a. The resistance controlling component 90a is movably disposed in the mount hole 811a. The resistance controlling component 90a is, for example, in a tapered pillar. As shown, the resistance controlling component 90a tapers towards the chain guide 20a so that the outer diameter of the resistance controlling component 90a decreases towards the chain guide 20a (e.g., R1 and R2 shown in FIG. 3).

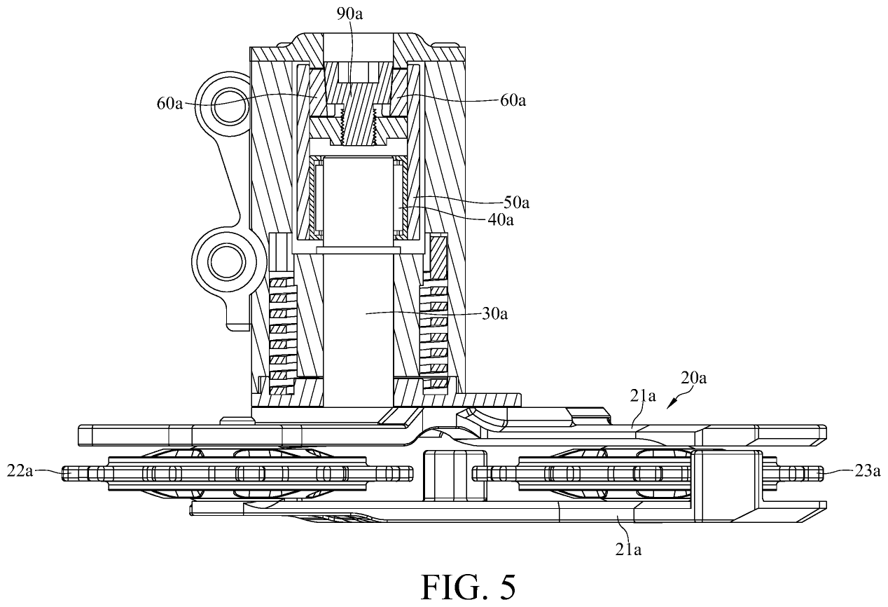

Then, referring to FIGS. 3 to 5, FIG. 5 is a cross-sectional view of the bicycle rear derailleur 1a in FIG. 1 when the resistance applying components 60a press against the annular surface 52a of the connecting component 50a

The resistance controlling component 90a can be rotated and moved towards the chain guide 20a along the axial direction of the pivot 30a by being driven by an ordinary hex key. By doing so, the resistance controlling component 90a radially pushes outwards the resistance applying components 60a, such that the resistance applying components 60a are forced to tightly press against the annular inner surface 52a of the connecting component 50a. At this moment, the resistance to the rotational movement of the connecting component 50a is increased, such that the resistance for the pivot 30a to rotate the one-way bearing 40a and the connecting component 50a in the rotation direction D2 is increased as well. As a result, the resistance to the rotational movement of the pivot 30a in the rotation direction D2 and to the movement of the chain guide 20a in a direction opposite to the pivot direction D1 is increased. As such, the movement of the chain guide 20a in a direction opposite to the pivot direction D1 caused by impact or vibration is largely decreased, which prevents the bicycle chain from falling off from the bicycle rear cassette.

On the other hand, the rotational resistance that the resistance applying components 60a applies to the chain guide 20a can be removed by moving the resistance controlling component 90a in a direction away from the chain guide 20a. By doing so, the chain guide 20a becomes easier to be pivoted along the direction opposite the pivot direction D1, thereby facilitating the removal of the bicycle derailleur from the bicycle frame.

As discussed, it is understood that the rotational resistance provided by resistance applying components 60a can be adjusted by the resistance controlling component 90a, but the present disclosure is not limited thereto. In some other embodiments, the bicycle rear derailleur may have no resistance controlling component; in such a case, the resistance applying components may be fixed on the pillar portion of the mount component and cannot be moved with respect to the pillar portion of the mount component. As such, the resistance force provided by the resistance applying component is maintained in a constant value.

In addition, the quantity of the resistance applying components 60a is not restricted; in some other embodiments, the bicycle rear derailleur may have only one resistance applying component.

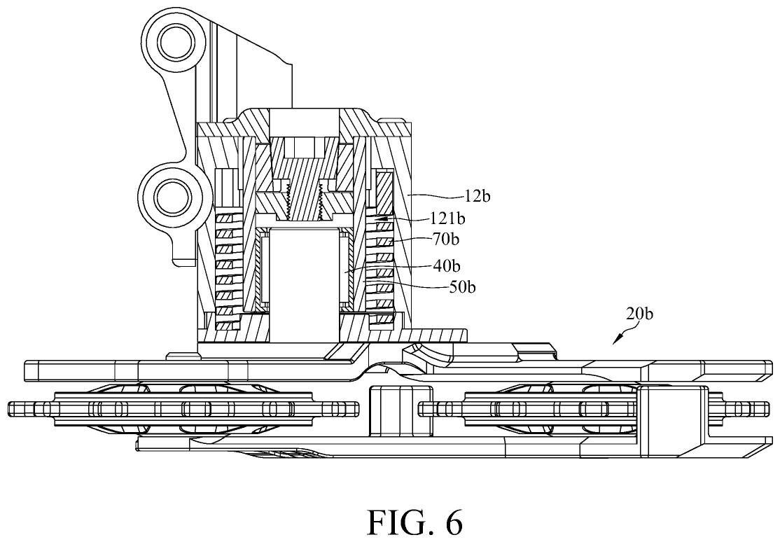

Moreover, the one-way bearing 40a and the elastic component 70a are not restricted to be arranged along the axial direction of the pivot 30a. For example, referring to FIG. 6, FIG. 6 is a cross-sectional view of a bicycle rear derailleur according to a second embodiment of the disclosure.

Note that the one of the main difference between the bicycle rear derailleur and the bicycle rear derailleur 1a illustrated in the previous embodiments is the arrangement of the elastic component and the one-way bearing, thus only the differences between these embodiments will be illustrated below, and the same and similar parts will not be repeated.

In this embodiment, a movable component 12b and a chain guide 20b together form a first accommodation space 121b therebetween. A one-way bearing 40b, a connecting component 50b and an elastic component 70b are located in the first accommodation space 121b, and the elastic component 70b surrounds the one-way bearing 40b.

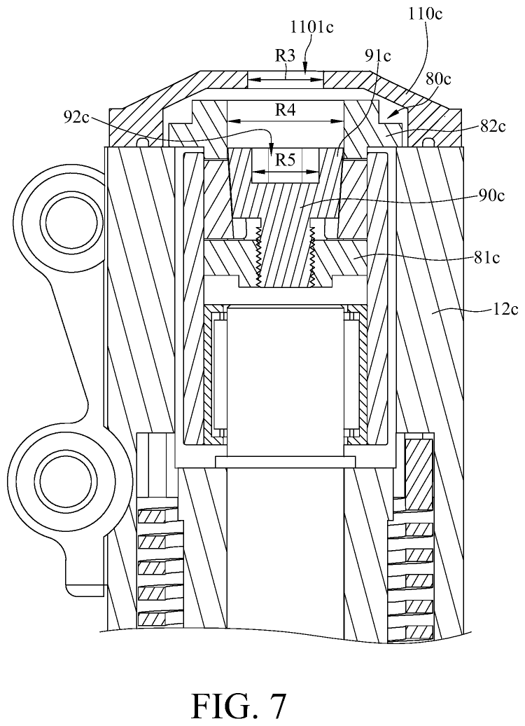

Then, referring to FIG. 7, FIG. 7 is a partial cross-sectional view of a bicycle rear derailleur according to third second embodiment of the disclosure.

Note that the one of the main difference between the bicycle rear derailleur and the bicycle rear derailleur 1a illustrated in the previous embodiments is the configuration of cover, thus only the differences will be illustrated below, and the same and similar parts will not be repeated.

In this embodiment, the bicycle rear derailleur further includes a cover 110c. The cover 110c is mounted on a movable component 12c and covers a flange portion 82c of a mount component 80c. A resistance controlling component 90c is, for example, a screw. As shown, the resistance controlling component 90c has a head portion 91c and a hole 92c located on the head portion 91. The hole 92c is configured for the engagement of a screw driver (e.g., an ordinary hex key) and for rotating the resistance controlling component 90c. The cover 110c has a through hole 1101c. A hole diameter R3 of the through hole 1101c is smaller than an outer diameter R4 of the head portion 91c of the resistance controlling component 90c and is larger than a hole diameter R5 of the hole 92c. As such, the resistance controlling component 90c is prevented from passing through the through hole 1101c.

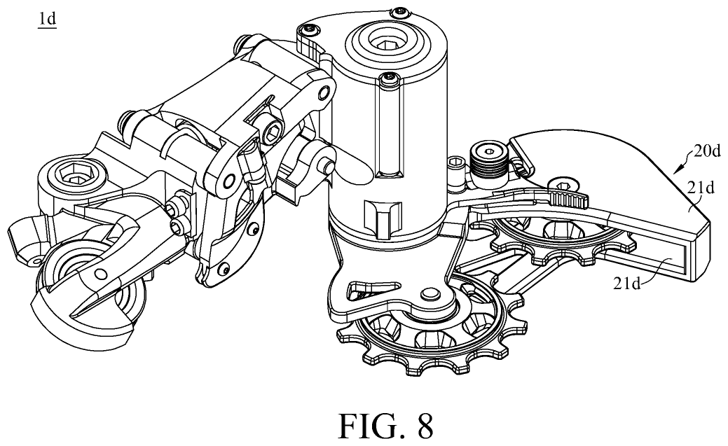

Then, referring to FIG. 8, FIG. 8 is a perspective view of a bicycle rear derailleur 1d according to a fourth embodiment of the disclosure.

Note that the one of the main difference between the bicycle rear derailleur and the bicycle rear derailleur 1a illustrated in the previous embodiments is the configuration of the frame bodies of the chain guide, thus only the differences will be illustrated below, and the same and similar parts will not be repeated.

In this embodiment, two frame bodies 21d of a chain guide 20d of the bicycle rear derailleur 1d are made of a single piece, where the frame bodies 21d may be made of metal or non-metal material. The non-metal material is, for example, a carbon fiber compound or a glass fiber compound.

According to the bicycle rear derailleurs as discussed above, the resistance applying components are able to radially press against the connecting component to resist the rotational movement of the connecting component, such that the resistance for the pivot to rotate the one-way bearing and the connecting component is increased as well. As a result, the resistance to the rotational movement of the pivot and to the movement of the chain guide is increased. Therefore, the movement of the chain guide caused by impact or vibration is largely decreased, which prevents the bicycle chain from falling off from the bicycle rear cassette.

In addition, the rotational resistance that the resistance applying components applies to the chain guide can be removed by moving the resistance controlling component in the direction away from the chain guide, such that the chain guide becomes easier to be pivoted, thereby facilitating the removal of the bicycle derailleur from the bicycle frame.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A bicycle rear derailleur, configured to be mounted on a bicycle frame, comprising:
a linkage assembly;
a chain guide;
a pivot, wherein an end of the pivot is fixed on the chain guide;
a one-way bearing, sleeved on the pivot;
a connecting component, disposed on the linkage assembly and connected to the one-way bearing, wherein the one-way bearing allows the pivot to rotate with respect to the connecting component only in a rotation direction; and
at least one resistance applying component, being radially movable, wherein the at least one resistance applying component is configured to radially press against the connecting component to provide resistance to rotational movements of the pivot, the one-way bearing, and the connecting component in a direction opposite to the rotation direction.

2. The bicycle rear derailleur according to claim 1, wherein the connecting component is a sleeve, the connecting component has an insertion hole and an annular inner surface forming the insertion hole, the one-way bearing is located in the insertion hole of the connecting component and is in tight contact with the annular inner surface of the connecting component, and at least one resistance applying component is located in the insertion hole of the connecting component and is configured to press against the annular inner surface of the connecting component.

3. The bicycle rear derailleur according to claim 2, further comprising a mount component, wherein the mount component comprises a pillar portion and a flange portion, the flange portion radially protrudes from the pillar portion, the flange portion is fixed on the linkage assembly, the pillar portion is partially located in the insertion hole of the connecting component, the at least one resistance applying component is disposed on the portion of the pillar portion located in the insertion hole.

4. The bicycle rear derailleur according to claim 3, further comprising a resistance controlling component, wherein the pillar portion of the mount component has a mount hole, the at least one resistance applying component is located between the mount hole and the annular inner surface, the resistance controlling component is movably disposed in the mount hole, and the resistance controlling component is movable towards the chain guide along an axial direction of the pivot to press against the at least one resistance applying component.

5. The bicycle rear derailleur according to claim 4, wherein the resistance controlling component is in a tapered pillar, the resistance controlling component tapers towards the chain guide.

6. The bicycle rear derailleur according to claim 4, further comprising a cover, wherein the resistance controlling component is a screw, the resistance controlling component has a head portion and a hole located on the head portion, the cover is mounted on the linkage assembly and covers the flange portion of the mount component, the cover has a through hole, and a hole diameter of the through hole of the cover is smaller than an outer diameter of the head portion and is larger than a hole diameter of the hole of the resistance controlling component.

7. The bicycle rear derailleur according to claim 3, wherein the at least one resistance applying component and the pillar portion of the mount component are separate pieces.

8. The bicycle rear derailleur according to claim 1, further comprising an elastic component, wherein two opposite ends of the elastic component are respectively fixed to the linkage assembly and the chain guide.

9. The bicycle rear derailleur according to claim 8, wherein the elastic component and the one-way bearing are arranged along an axial direction of the pivot.

10. The bicycle rear derailleur according to claim 9, wherein the linkage assembly includes a fixed component, a movable component and two links, two opposite ends of each of the links are respectively and pivotably disposed on the fixed component and the movable component, the movable component has a first accommodation space and a second accommodation space connected to each other, the pivot is disposed through the second accommodation space, the pivot is partially located in the second accommodation space and partially located in the first accommodation space, the one-way bearing and the connecting component are located in the first accommodation space, the movable component and the chain guide together form an annular space therebetween, the annular space surrounds the second accommodation space, and the elastic component is located in the annular space.

11. The bicycle rear derailleur according to claim 8, wherein the elastic component surrounds the one-way bearing.

12. The bicycle rear derailleur according to claim 11, wherein the linkage assembly comprises a fixed component, a movable component and two links, two opposite ends of each of the links are respectively and pivotably disposed on the fixed component and the movable component, the movable component and the chain guide together form a first accommodation space, the one-way bearing, the connecting component and the elastic component are located in the first accommodation space.

13. The bicycle rear derailleur according to claim 1, wherein the chain guide comprises two frame bodies, a guide pulley and a tension pulley, the guide pulley and the tension pulley are rotatably located between the frame bodies, and the end of the pivot is fixed on one of the frame body.

14. The bicycle rear derailleur according to claim 13, wherein the frame bodies are separate pieces, the frame bodies are made of metal or non-metal material, or the frame bodies are respectively a metal piece and a non-metal piece.

15. The bicycle rear derailleur according to claim 13, wherein the frame bodies are made of a single piece, the frame bodies are made of metal or non-metal material.
